(19) United States
(12) Patent Application Publication
(10) Pub. No.: US 2023/0286744 A1
(43) Pub. Date: Sep. 14, 2023

(54) CLOTHING CAROUSEL ASSEMBLY

(71) Applicant: PACLINE CORPORATION, Mississauga (CA)

(72) Inventor: Karl Joseph KARULSKI, Burlington (CA)

(21) Appl. No.: 18/181,396

(22) Filed: Mar. 9, 2023

Related U.S. Application Data
(60) Provisional application No. 63/318,177, filed on Mar. 9, 2022.

(51) Int. Cl. B65G 1/04; A47B 61/02; A47B 49/00

(52) U.S. Cl. CPC B65G 1/0457; A47B 61/02; A47B 49/00

(57) ABSTRACT

A clothing carousel assembly is configured to receive, support, and selectively rotate clothing hangers, with clothing items hanging from the clothing hangers, along a rotation path. The clothing carousel assembly is also configured to be positioned between the opposite walls of a closet. The clothing carousel assembly includes (preferably defines) weight-transfer receivers configured to receive (either directly or indirectly) and contact (either directly or indirectly) the elongated weight-transfer members.

### CROSS-REFERENCE TO RELATED APPLICATIONS

This application claims the benefit of U.S. Provisional Patent Application No. 63/318,177, filed Mar. 9, 2022, the contents of which are incorporated herein by reference in their entirety.

### TECHNICAL FIELD

This document relates to the technical field of (and is not limited to) a clothing carousel assembly and a method therefor.

### BACKGROUND

A clothing carousel is configured to receive, support, and selectively rotate (revolve) clothing hangers with the clothing items along a rotation path.

### SUMMARY

It will be appreciated that there exists a need to mitigate (at least in part) at least one problem associated with known clothing carousels. After much study of, and experimentation with, known clothing carousels, there is provided an understanding of the problem and the solution articulated as follows:

The dimensions of closets are not standard. The distance between opposite walls of closets may vary. What is needed is a clothing carousel configured to be installable within, or between, the opposite side walls of various closets having different distances between the opposite walls of the closets. It will be appreciated that other problems and solutions are also described and/or depicted, either explicitly or implicitly.

There is provided, in accordance with a first major aspect, an apparatus to mitigate, at least in part, at least one problem associated with the existing technology. The apparatus is for (use with) a closet having opposite walls. The apparatus is also for (use with) clothing hangers configured to receive and support clothing items. The apparatus is also for (use with) the elongated weight-transfer members configured to be securely connectable, either directly or indirectly, to the opposite walls of the closet. The apparatus includes and is not limited to (comprises) a clothing carousel assembly configured to receive, support, and selectively rotate the clothing hangers with the clothing items hanging from the clothing hangers along a rotation path. The clothing carousel assembly is also configured to be positioned between the opposite walls of a closet. It will be appreciated that the clothing carousel assembly is positioned to be spaced apart from a floor of the closet. The clothing carousel assembly includes weight-transfer receivers configured to receive (at least in part, either directly and/or indirectly) and contact (at least in part, either directly and/or indirectly) the elongated weight-transfer members. It is preferred that the clothing carousel assembly defines the weight-transfer receivers. In accordance with a first preferred embodiment of the apparatus, the elongated weight-transfer members are also configured to be securely connectable (at least in part, either directly and/or indirectly) to the opposite walls of the closet. In accordance with a second preferred embodiment of the apparatus, the elongated weight-transfer members are also configured to receive, support and transfer the weight of the clothing carousel assembly (preferably, also including the weight of the clothing hangers with the clothing items) to the opposite walls of the closet after: (A) the weight-transfer receivers, of the clothing carousel assembly, receive (at least in part, either directly and/or indirectly) and contact (at least in part, either directly and/or indirectly) the elongated weight-transfer members; and (B) the clothing carousel assembly is positioned between the opposite walls of the closet; and (C) the elongated weight-transfer members are securely connected (at least in part, either directly and/or indirectly) to the opposite walls of the closet. In accordance with a third preferred embodiment of the apparatus, the weight-transfer receivers form elongated hollow structures (preferably, elongated structures, tubular structures, etc.) positioned at respective corner zones of the clothing carousel assembly. The elongated weight-transfer members are configured to be slide receivable, at least in part, within the respective corner zones of the clothing carousel assembly. In accordance with a fourth preferred embodiment of the apparatus, the apparatus further includes a lock device configured to selectively lock the weight-transfer receivers to the elongated weight-transfer members after the weight-transfer receivers receive (at least in part, either directly and/or indirectly) and contact (at least in part, either directly and/or indirectly) the elongated weight-transfer members. Preferably, the elongated weight-transfer members are configured to be slide receivable, at least in part, within the elongated structures of the weight-transfer receivers that are respectively located at the respective corner zones of the clothing carousel assembly.

To mitigate, at least in part, at least one problem associated with the existing technology, there is provided (in accordance with a second major aspect) a method. The method is for installing a clothing carousel assembly, having weight-transfer receivers, in a closet having opposite walls. The clothing carousel assembly is configured to receive, support, and selectively rotate clothing hangers, with the clothing items hanging from the clothing hangers, along a rotation path. The method includes and is not limited to (comprises) receiving (at least in part, either directly and/or indirectly) and contacting (at least in part, either directly and/or indirectly) the elongated weight-transfer members to the weight-transfer receivers of the clothing carousel assembly. The method also includes positioning the clothing carousel assembly between the opposite walls of the closet. It will be appreciated that the clothing carousel assembly is positioned to be spaced apart from a floor of the closet. The method also includes securely connecting (at least in part, either directly and/or indirectly) the elongated weight-transfer members with the opposite walls of the closet. The elongated weight-transfer members receive, support, and transfer the weight of the clothing carousel assembly (preferably including the clothing hangers with the clothing items) to the opposite walls of the closet after: (A) the weight-transfer receivers receive (at least in part, either directly and/or indirectly) and contact (at least in part, either directly and/or indirectly) the elongated weight-transfer members; and (B) the clothing carousel assembly is positioned between the opposite walls of the closet; and (C) the elongated weight-transfer members are securely connected (at least in part, either directly and/or indirectly) to the opposite walls of the closet. It will be appreciated that the clothing carousel assembly is spaced apart from a floor of the closet when or after the clothing carousel assembly is positioned between the opposite walls of the closet.

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in simplified form that are further described below in the Detailed Description. This Summary is not intended to identify potentially key features or possible essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 and FIG. 2 depict a lower perspective view (FIG. 1) and an upper perspective view (FIG. 2) of embodiments of a clothing carousel assembly; and

FIG. 3 and FIG. 4 depict upper perspective views of embodiments of the clothing carousel assembly of FIG. 1; and

FIG. 5, FIG. 6, and FIG. 7 depict a rear side view (FIG. 5), and front side views (FIG. 6 and FIG. 7) of embodiments of the clothing carousel assembly of FIG. 1; and

FIG. 8 and FIG. 9 depict front side views of embodiments of the clothing carousel assembly of FIG. 1; and

FIG. 10 depicts a top view of an embodiment of a closet for use with the clothing carousel assembly of FIG. 1; and

FIG. 11 and FIG. 12 depict bottom views of embodiments of the clothing carousel assembly of FIG. 1; and

FIG. 13 and FIG. 14 depict a bottom view (FIG. 13) and a top view (FIG. 14) of embodiments of the clothing carousel assembly of FIG. 1; and

FIG. 15, FIG. 16, and FIG. 17 depict side perspective views of embodiments of elongated weight-transfer members for the clothing carousel assembly of FIG. 1; and

FIG. 18 and FIG. 19 depict upper perspective views of embodiments of the clothing carousel assembly of FIG. 1; and

FIG. 20, FIG. 21, FIG. 22, and FIG. 23 depict lower perspective views of embodiments of the clothing carousel assembly of FIG. 1; and

FIG. 24, FIG. 25, FIG. 26, and FIG. 27 depict upper perspective views of embodiments of the clothing carousel assembly of FIG. 1.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, and well-understood, elements that are useful in commercially feasible embodiments are often not depicted to provide a less obstructed view of the embodiments of the present disclosure.

### LISTING OF REFERENCE NUMERALS USED IN THE DRAWINGS

apparatus 100
clothing carousel assembly 200
support structure 201
rotation path 202
weight-transfer receivers (211, 212, 213, 214)
respective corner zones (221, 222, 223, 224)
interior space 229
track assembly 230
track receiver 232
motor 234
front cover 236
lock device 238
elongated weight-transfer members (411, 412, 413, 414)
retracted position
extended position
support members (501, 502)
stop members (503A, 503B)
connector 504
telescopic weight-transfer member 600
first distance 701
second distance 702
closet 900
opposite walls (901, 902)
floor 903
clothing hangers (904A, 904B)
clothing items (906A, 906B)
user 908
storage box 910
upper surface 911

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the disclosure is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the disclosure is limited to the subject matter provided by the claims, and that the disclosure is not limited to the particular aspects depicted and described. It will be appreciated that the scope of the meaning of a device configured to be coupled to an item (that is, to be connected to, to interact with the item, etc.) is to be interpreted as the device being configured to be coupled to the item, either directly or indirectly. Therefore, “configured to” may include the meaning “either directly or indirectly” unless specifically stated otherwise.

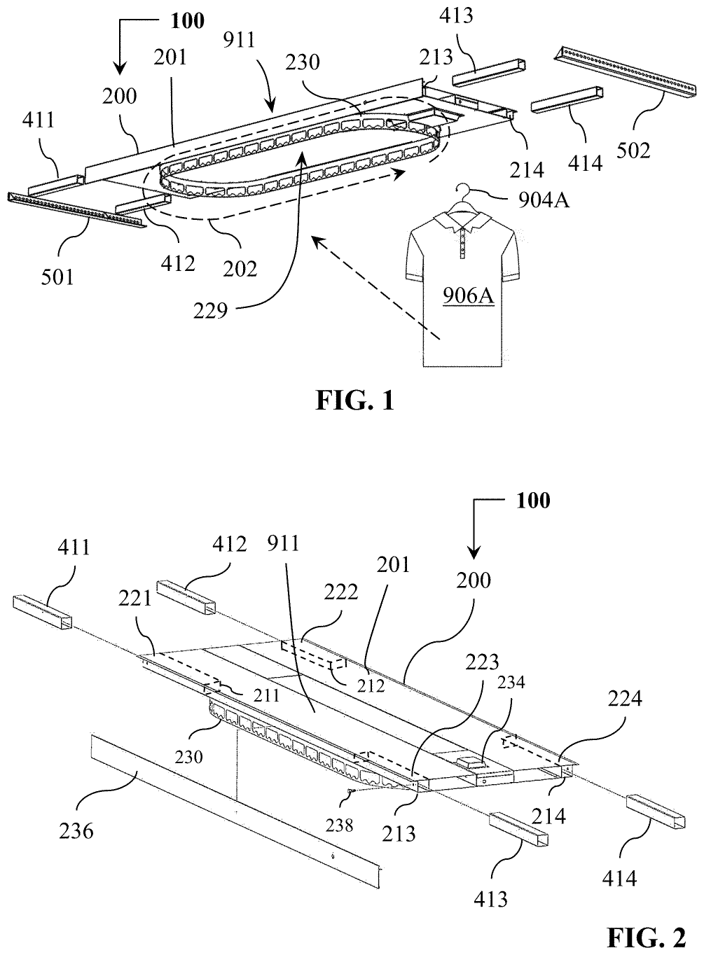

FIG. 1 and FIG. 2 depict a lower perspective view (FIG. 1) and an upper perspective view (FIG. 2) of embodiments of an apparatus 100 that includes a clothing carousel assembly 200.

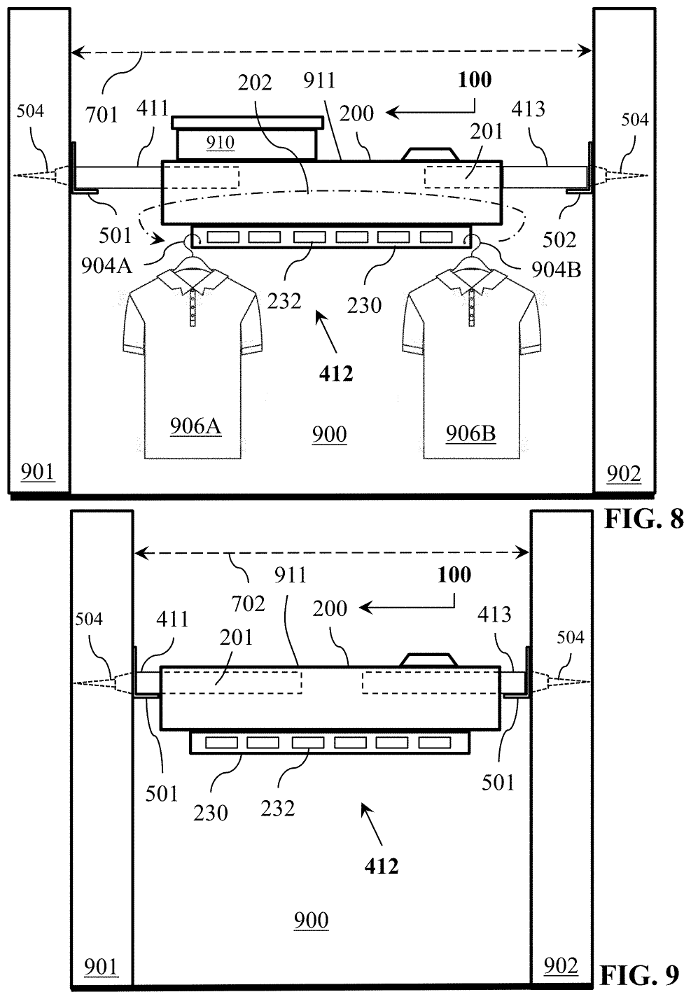

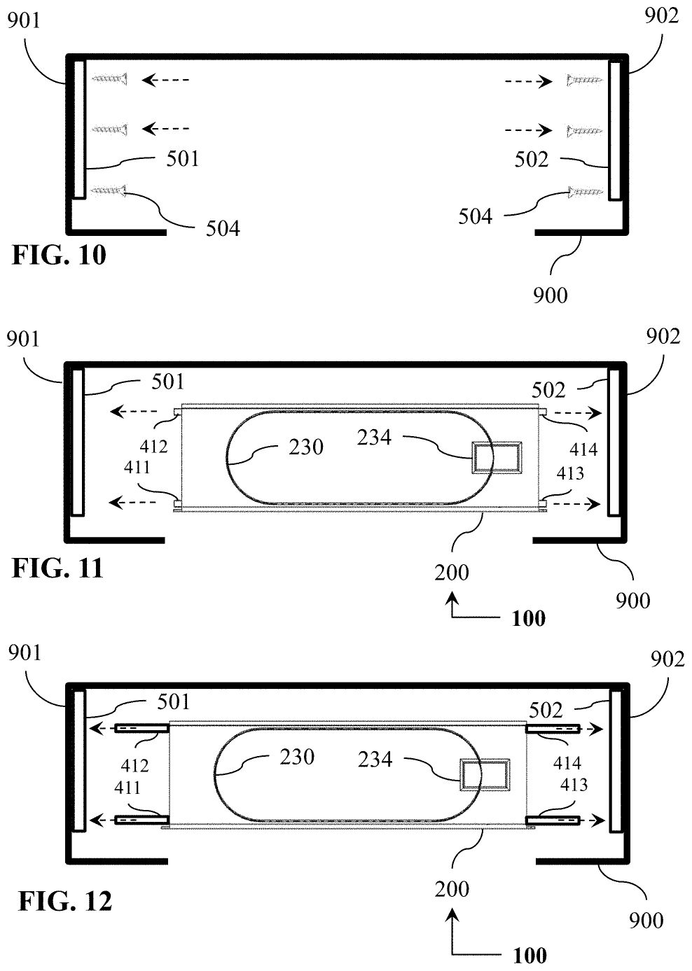

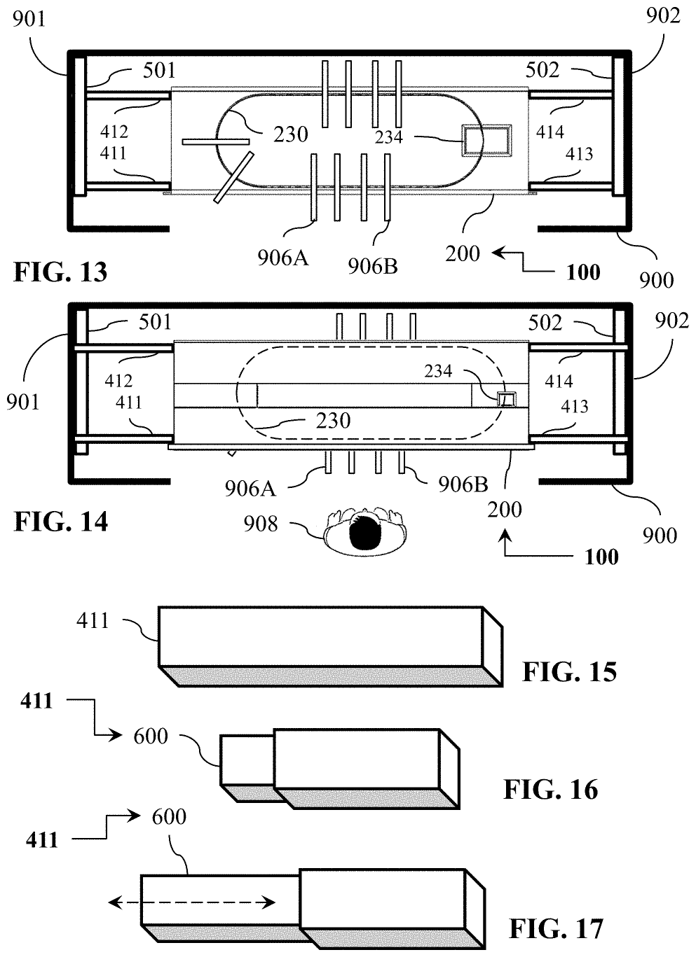

Referring to the embodiments as depicted in FIG. 1 and FIG. 2, the clothing carousel assembly 200 is for (use with) a closet 900 having opposite walls (901, 902). The clothing carousel assembly 200 may include a front cover 236 (also called a control panel with user control buttons). The clothing carousel assembly 200 includes, preferably, a track assembly 230, and a motor 234 configured to selectively urge rotational movement of the track assembly 230. The clothing carousel assembly 200 includes components made of metal, sheet metal, plastic parts, etc. Embodiments of the closet 900 are depicted in FIG. 7, FIG. 8, FIG. 9, FIG. 10, FIG. 11, FIG. 12, FIG. 13, and FIG. 14. The clothing carousel assembly 200 is formed, preferably, with metal components, etc.

Referring to the embodiments as depicted in FIG. 1 and FIG. 8, the clothing carousel assembly 200 is also for (use with) clothing hangers (904A, 904B). The track assembly 230 is configured to receive the hook portions of the clothing hangers (904A, 904B). The clothing hangers (904A, 904B) are configured to receive and support clothing items (906A, 906B).

The track assembly 230 defines an interior space 229. In other words, the track assembly 230 extends along a path (otherwise referred to as a loop or a circuit) that surrounds the interior space 229.

Referring to the embodiments as depicted in FIG. 1 and FIG. 2, the clothing carousel assembly 200 is also for (use with) the elongated weight-transfer members (411, 412, 413, 414) configured to be securely connectable to the opposite walls (901, 902) of the closet 900 (as depicted in FIG. 7, FIG. 8, FIG. 9, FIG. 10, FIG. 11, FIG. 12, FIG. 13, and FIG. 14).

Referring to the embodiments as depicted in FIG. 1 and FIG. 8, the clothing carousel assembly 200 is configured to receive, support, and selectively rotate the clothing hangers (904A, 904B) with the clothing items (906A, 906B) hanging from the clothing hangers (904A, 904B) along a rotation path 202.

Referring to the embodiment as depicted in FIG. 7, the clothing carousel assembly 200 is also configured to be positioned between the opposite walls (901, 902) of the closet 900.

Referring to the embodiment as depicted in FIG. 2, the clothing carousel assembly 200 includes a support structure 201 that supports the track assembly 230 and the motor 234. The support structure 201 includes a plurality of weight-transfer receivers (211, 212, 213, 214) configured to receive (at least in part, either directly or indirectly) and (made to) contact (at least in part, either directly or indirectly) the elongated weight-transfer members (411, 412, 413, 414).

Referring to the embodiments of FIG. 1 and FIG. 2, the clothing carousel assembly 200 is for (use with) a closet 900 having opposite walls (901, 902). The clothing carousel assembly 200 is also for (use with) clothing hangers (904A, 904B) configured to receive and support clothing items (906A, 906B). The clothing carousel assembly 200 is also for (use with) the elongated weight-transfer members (411, 412, 413, 414) configured to be securely connectable, either directly or indirectly, to the opposite walls (901, 902) of the closet 900. The clothing carousel assembly 200 is configured to receive (at least in part, either directly or indirectly), support (at least in part, either directly and/or indirectly), and selectively rotate (at least in part, either directly and/or indirectly) the clothing hangers (904A, 904B) with the clothing items (906A, 906B) hanging from the clothing hangers (904A, 904B) along the rotation path 202. The clothing carousel assembly 200 is also configured to be positioned between the opposite walls (901, 902) of a closet 900, and spaced apart from a floor 903 of the closet 900. The clothing carousel assembly 200 includes (preferably defines) the weight-transfer receivers (211, 212, 213, 214) configured to receive (at least in part, either directly and/or indirectly) and contact (at least in part, either directly and/or indirectly) the elongated weight-transfer members (411, 412, 413, 414). The clothing carousel assembly 200 may be called a rotatable clothing carousel assembly or a revolvable clothing carousel assembly, etc. The elongated weight-transfer members (411, 412, 413, 414) have a length that permits fitting the clothing carousel assembly 200 within the distance between the opposite walls (901, 902) of the closet 900. The elongated weight-transfer members (411, 412, 413, 414) may be cut to length, on site, to fit a distance between the opposite walls (901, 902) of the closet 900, if desired.

Referring to the embodiments of FIG. 1 and FIG. 2, the weight-transfer receivers (211, 212, 213, 214), preferably, form elongated structures (hollow tubular structures) positioned at respective corner zones (221, 222, 223, 224) of the clothing carousel assembly 200. The elongated weight-transfer members (411, 412, 413, 414) are configured, preferably, to be slide receivable, at least in part, within the respective corner zones (221, 222, 223, 224) of the clothing carousel assembly 200. Preferably, the elongated weight-transfer members (411, 412, 413, 414) are configured to be slide receivable, at least in part, within the elongated structures of the weight-transfer receivers (211, 212, 213, 214) that are respectively located at the respective corner zones (221, 222, 223, 224) of the clothing carousel assembly 200.

Referring to the embodiments of FIG. 1 and FIG. 2, the elongated weight-transfer members (411, 412, 413, 414) are also configured, preferably, to be slide engageable with (supported by) the clothing carousel assembly 200.

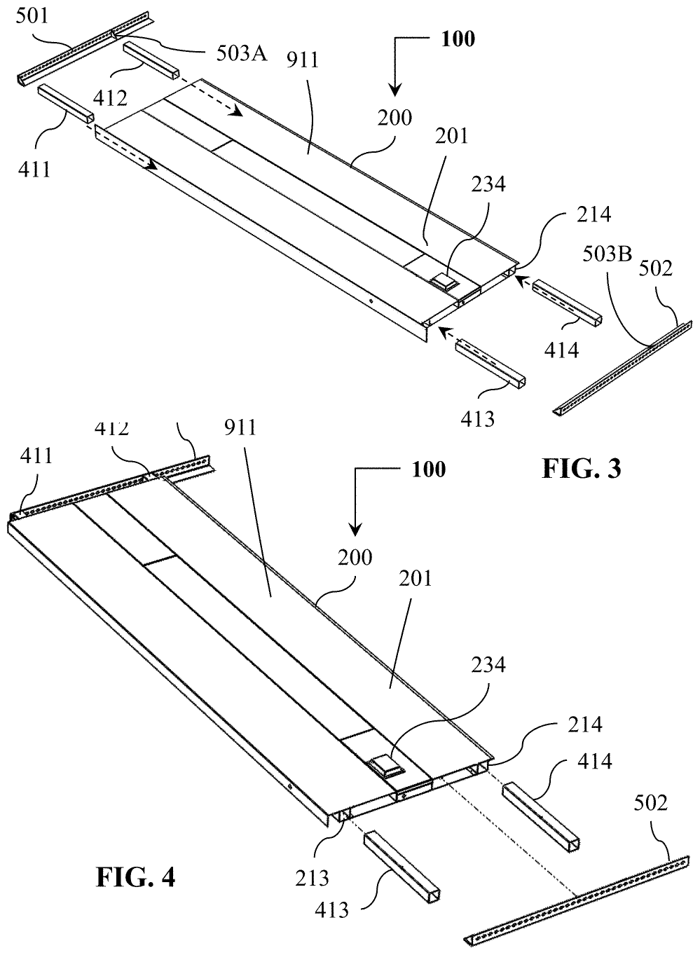

FIG. 3 and FIG. 4 depict upper perspective views of embodiments of the clothing carousel assembly 200 of FIG. 1.

Referring to the embodiments as depicted in FIG. 3 and FIG. 4, the support members (501, 502) include a first stop member 503A and a second stop member 503B. The stop members (503A, 503B) are positioned between the end portions of the support members (501, 502). The stop members (503A, 503B) are configured to stop, at least in part, inadvertent movement of the clothing carousel assembly 200 after the elongated weight-transfer members (411, 412, 413, 414) are (A) extended from the interior of the clothing carousel assembly 200, and (B) positioned on the support members (501, 502).

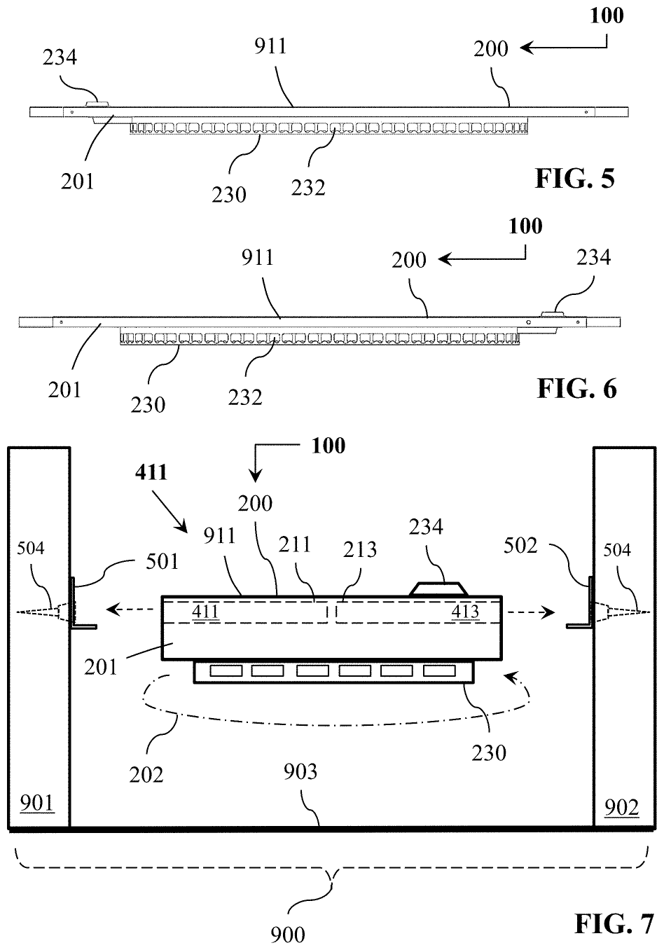

FIG. 5 and FIG. 6 depict a rear side view (FIG. 5) and a front side view (FIG. 6) of embodiments of the clothing carousel assembly 200 of FIG. 1.

Referring to the embodiments as depicted in FIG. 5 and FIG. 6, the track assembly 230 includes (defines) track receivers 232 positioned along an elongated length of the track assembly 230.

FIG. 7 depicts a front side view of an embodiment of the clothing carousel assembly 200 of FIG. 1.

Referring to the embodiment as depicted in FIG. 7, the clothing carousel assembly 200 is positioned between the opposite walls (901, 902) of the closet 900, and offset from the floor 903 of the closet 900. The elongated weight-transfer members (411, 412) face the first wall 901. The elongated weight-transfer members (413, 414) face the second wall 902. The track assembly 230 faces the floor 903. The elongated weight-transfer members (411, 412) are placed in their respective retracted positions (as depicted in FIG. 7). The elongated weight-transfer members (411, 412) are configured to extend to, and make contact with, the first support member 501 which is securely mounted to the first wall 901. The elongated weight-transfer members (413, 414) are configured to extend to, and make contact with, the second support member 502 which is securely mounted to the second wall 902.

Referring to the embodiments of FIG. 2 and FIG. 7, in a retracted position, the elongated weight-transfer members (411, 412, 413, 414) are retracted, at least in part, into the interior of the clothing carousel assembly 200. This arrangement is done in such a way that the elongated weight-transfer members (411, 412, 413, 414) are spaced-apart from the support members (501, 502) mounted to the opposite walls of the closet after the clothing carousel assembly 200 is positioned between the opposite walls (901, 902) of the closet 900.

FIG. 8 and FIG. 9 depict front side views of embodiments of the clothing carousel assembly 200 of FIG. 1.

Referring to the embodiment as depicted in FIG. 8, the clothing carousel assembly 200 is secured to the opposite walls (901, 902). The elongated weight-transfer members (411, 412) are placed in their extended position as depicted in FIG. 8. A storage box 910 may be placed on the upper surface of the support structure 201 of the clothing carousel assembly 200 if so desired. The upper surface is shown at 911 in FIG. 8. The opposite walls (901, 902) are separated by a first distance 701. The elongated weight-transfer members (411, 412, 413, 414) extend further out from the interior of the clothing carousel assembly 200 to accommodate the first distance 701 between the opposite walls (901, 902).

In some embodiments, the upper surface 911 may form a shelf for storage of items (e.g. other items of clothing). In some embodiments, the upper surface 911 extends across the interior aperture 229 (FIG. 1) that is defined by the track assembly 230, thereby preventing any clothing from falling through the interior aperture 229 (FIG. 1). In some embodiments, the upper surface 911 extends across the interior aperture 229 and is contiguous such that it is free of any pass-through apertures that are sufficiently large enough to permit an item of clothing to pass therethrough. For the purpose of defining ‘item of clothing’, an item of clothing may include a pair of pants, a pair of shorts, a shirt, or a blouse, which would fit a 50% percentile-sized adult human. Optionally, the upper surface 911 is flat, apart from any fastener heads, and apart from the motor 234.

Referring to the embodiment as depicted in FIG. 9, the opposite walls (901, 902) are separated by a second distance 702. The elongated weight-transfer members (411, 412) are placed in their extended position as depicted in FIG. 8. The second distance 702 of FIG. 9 is shorter than the first distance 701 of FIG. 8. The elongated weight-transfer members (411, 412, 413, 414) extend further out from the interior of the clothing carousel assembly 200 to accommodate the second distance 702 between the opposite walls (901, 902).

Referring to the embodiments of FIG. 7 and FIG. 8, the elongated weight-transfer members (411, 412, 413, 414) are also configured, preferably, to be securely connectable (at least in part, either directly and/or indirectly) to the opposite walls (901, 902) of the closet 900. The elongated weight-transfer members (411, 412, 413, 414) are also configured, preferably, to receive, support and transfer the weight of the clothing carousel assembly 200, preferably also including the weight of the clothing hangers (904A, 904B) with the clothing items (906A, 906B), to the opposite walls (901, 902) of the closet 900. This arrangement is done after: (A) the weight-transfer receivers (211, 212, 213, 214), of the clothing carousel assembly 200, receive (at least in part, either directly and/or indirectly) and contact (at least in part, either directly and/or indirectly) the elongated weight-transfer members (411, 412, 413, 414); and (B) the clothing carousel assembly 200 is positioned between the opposite walls (901, 902) of the closet 900; and (C) the elongated weight-transfer members (411, 412, 413, 414) are securely connected (at least in part, either directly and/or indirectly) to the opposite walls (901, 902) of the closet 900.

Referring to the embodiments of FIG. 7 and FIG. 8, support members (501, 502) are configured to be securely attached to the opposite walls (901, 902) of the closet 900.

Referring to the embodiment of FIG. 8, the support members (501, 502) are also configured, preferably, to support the elongated weight-transfer members (411, 412, 413, 414).

Referring to the embodiment of FIG. 8, the support members (501, 502) are also configured, preferably, to support the elongated weight-transfer members (411, 412, 413, 414) along with the clothing carousel assembly 200 (preferably for the case where the clothing carousel assembly 200 is loaded with the clothing hangers including the clothing items, etc.). This arrangement is done after the support members (501, 502) are securely attached to the opposite walls (901, 902) of the closet 900, and after the elongated weight-transfer members (411, 412, 413, 414) are moved away from the clothing carousel assembly 200 and contact, at least in part, the support members (501, 502).

Referring to the embodiments of FIG. 8 and FIG. 9, the elongated weight-transfer members (411, 412, 413, 414) are also configured, preferably, to be connectable, either directly and/or indirectly, to the opposite walls (901, 902) of the closet 900. This arrangement is done in such a way that the elongated weight-transfer members (411, 412, 413, 414) transfer (either directly and/or indirectly) the weight of the clothing carousel assembly 200 supporting the clothing hangers (904A, 904B) with the clothing items (906A, 906B) toward the opposite walls (901, 902) of the closet 900 after the elongated weight-transfer members (411, 412, 413, 414) are connected, either directly or indirectly, to the opposite walls (901, 902) of the closet 900.

Referring to the embodiments of FIG. 7 and FIG. 8, a method is provided for installing the clothing carousel assembly 200, having the weight-transfer receivers (211, 212, 213, 214) in the closet 900. The closet 900 has opposite walls (901, 902), or spaced-apart opposite walls, etc. The clothing carousel assembly 200 is configured to receive, support, and selectively rotate clothing hangers (904A, 904B), with the clothing items (906A, 906B) hanging from the clothing hangers (904A, 904B), along a rotation path 202. The method includes the step of receiving (at least in part, either directly and/or indirectly) and contacting (at least in part, either directly and/or indirectly) the elongated weight-transfer members (411, 412, 413, 414) to the weight-transfer receivers (211, 212, 213, 214) of the clothing carousel assembly 200. The method also includes positioning the clothing carousel assembly 200 between the opposite walls (901, 902) of the closet 900 (and spaced apart from a floor 903 of a closet 900). The method also includes securely connecting (at least in part, either directly and/or indirectly) the elongated weight-transfer members (411, 412, 413, 414) with the opposite walls (901, 902) of the closet 900. The elongated weight-transfer members (411, 412, 413, 414) receive, support and transfer the weight of the clothing carousel assembly 200, including the clothing hangers (904A, 904B) with the clothing items (906A, 906B) to the opposite walls (901, 902) of the closet 900. This arrangement is done after: (A) the weight-transfer receivers (211, 212, 213, 214) receive (at least in part, either directly and/or indirectly) and contact (at least in part, either directly and/or indirectly) the elongated weight-transfer members (411, 412, 413, 414); and (B) the clothing carousel assembly 200 is positioned between the opposite walls (901, 902) of the closet 900 (and spaced apart from a floor 903 of the closet 900); and (C) the elongated weight-transfer members (411, 412, 413, 414) are securely connected (at least in part, either directly and/or indirectly) to the opposite walls (901, 902) of the closet 900.

Referring to the embodiments of FIG. 7 and FIG. 8, the method further includes connecting, either directly and/or indirectly, the elongated weight-transfer members (411, 412, 413, 414) to the opposite walls (901, 902) of the closet 900. This arrangement is done in such a way that the elongated weight-transfer members (411, 412, 413, 414) transfer (either directly and/or indirectly) the weight of the clothing carousel assembly 200 supporting the clothing hangers (904A, 904B) with the clothing items (906A, 906B) toward the opposite walls (901, 902) of the closet 900 after the elongated weight-transfer members (411, 412, 413, 414) are connected, either directly or indirectly, to the opposite walls (901, 902) of the closet 900.

Referring to the embodiments of FIG. 7 and FIG. 8, the method further includes extending, at least in part, the elongated weight-transfer members (411, 412, 413, 414) away from the clothing carousel assembly 200. This arrangement is done in such a way that the elongated weight-transfer members (411, 412, 413, 414) are movable between a retracted position and an extended position.

Referring to the embodiments of FIG. 7 and FIG. 8, the method further includes securely attaching support members (501, 502) to the opposite walls (901, 902) of the closet 900, in which the support members (501, 502) are configured to support the elongated weight-transfer members (411, 412, 413, 414) and the clothing carousel assembly 200 (and further weight added to the clothing carousel assembly 200, such as clothing items, clothing hangers, etc.) after the support members (501, 502) are securely attached to the opposite walls (901, 902) of the closet 900, and after the elongated weight-transfer members (411, 412, 413, 414) are moved away from the clothing carousel assembly 200 and contact, at least in part, the support members (501, 502). In the extended position, the elongated weight-transfer members (411, 412, 413, 414) are extended, at least in part, away from an interior of the clothing carousel assembly 200. This arrangement is done in such a way that the elongated weight-transfer members (411, 412, 413, 414) contact, at least in part, the support members (501, 502), and the support members (501, 502) support the elongated weight-transfer members (411, 412, 413, 414) and the clothing carousel assembly 200 after the support members (501, 502) are mounted to the opposite walls (901, 902) of the closet 900 and after the clothing carousel assembly 200 is positioned between the opposite walls (901, 902) of the closet 900.

FIG. 10 depicts a top view of an embodiment of a closet 900 for use with the clothing carousel assembly 200 of FIG. 1.

Referring to the embodiment as depicted in FIG. 10, the position of the support members (501, 502) is measured, and leveled accordingly, on the outer surface of the opposite walls (901, 902) of the closet 900. The support members (501, 502) are securely installed to the opposite walls (901, 902) by the connectors 504. The connectors 504 may include nails, screws, fasteners, and/or any equivalent thereof.

FIG. 11 and FIG. 12 depict bottom views of embodiments of the clothing carousel assembly 200 of FIG. 1.

Referring to the embodiment as depicted in FIG. 11, the lengths of the elongated weight-transfer members (411, 412, 413, 414) may be determined based on the distance between the opposite walls (901, 902), and may be cut or adjusted accordingly for the installation of the clothing carousel assembly 200. The elongated weight-transfer members (411, 412, 413, 414) are installed (retracted) into the interior of the clothing carousel assembly 200. The clothing carousel assembly 200 is positioned between the opposite walls (901, 902) of the closet 900.

Referring to the embodiment as depicted in FIG. 12, the elongated weight-transfer members (411, 412, 413, 414) are extended away from the interior of the clothing carousel assembly 200 toward the support members (501, 502) securely mounted to the opposite walls (901, 902) while the clothing carousel assembly 200 remains positioned away from the floor of the closet 900.

FIG. 13 and FIG. 14 depict a bottom view (FIG. 13) and a top view (FIG. 14) of embodiments of the clothing carousel assembly 200 of FIG. 1.

Referring to the embodiment as depicted in FIG. 13, the ends of the elongated weight-transfer members (411, 412, 413, 414) are positioned on the support members (501, 502) securely mounted to the opposite walls (901, 902).

Referring to the embodiment as depicted in FIG. 14, the user 908 may press a button (known and not depicted) configured to control activation of the motor 234 (electric motor). The motor 234 is operatively coupled (by way of a gear assembly) to the track assembly 230. Selective activation (by way of a known control panel, etc.) of the motor 234 urges rotational movement of the track assembly 230.

FIG. 15, FIG. 16, and FIG. 17 depict side perspective views of embodiments of elongated weight-transfer members (411, 412, 413, 414) for the clothing carousel assembly 200 of FIG. 1.

Referring to the embodiment as depicted in FIG. 15, the elongated weight-transfer member 411 may be any suitable length, and/or may be cut to a desired length (preferably, on site). It is preferred that the elongated weight-transfer member 411 is hollow, and has a square cross-section. Any suitable cross-section may be used. It will be appreciated that the description of the elongated weight-transfer member 411 is applicable to all of the elongated weight-transfer members (411, 412, 413, 414).

Referring to the embodiments as depicted in FIG. 16 and FIG. 17, the elongated weight-transfer member 411 includes a telescopic weight-transfer member 600 configured to selectively extend in a tube-in-tube relationship, which may further extend the reach of the elongated weight-transfer member 411. Worded more broadly, the telescopic weight-transfer member is an example of a selectively extendable weight-transfer member, which can be extended through a range of positions relative to the support structure 201.

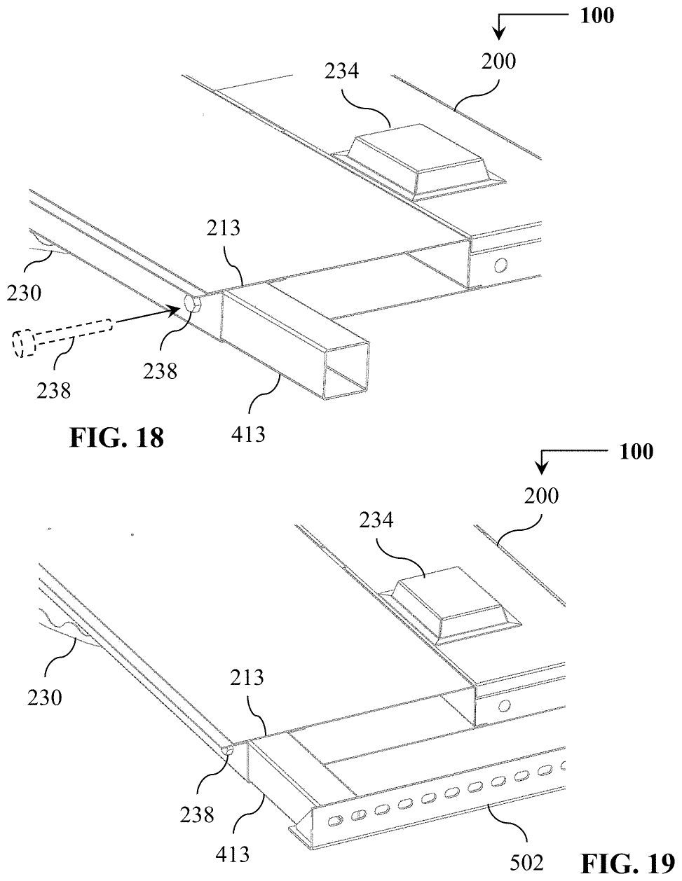

FIG. 18 and FIG. 19 depict upper perspective views of embodiments of the clothing carousel assembly 200 of FIG. 1.

Referring to the embodiment as depicted in FIG. 18, the clothing carousel assembly 200 includes a lock device 238. The clothing carousel assembly 200 defines a lock receiver (hidden from view) configured to threadably receive the lock device 238. The lock device 238 is configured to prevent the elongated weight-transfer member 413 from inadvertently moving back into the interior of the clothing carousel assembly 200, thereby preventing the clothing carousel assembly 200 from falling away from the support members (501, 502). The elongated weight-transfer member 413 is inserted (at least in part) into the interior of the clothing carousel assembly 200. The lock device 238 is configured to be inserted (rotatably inserted) into the lock receiver (defined by the clothing carousel assembly 200). The lock device 238 is also configured to securely connect the elongated weight-transfer member 413 to the clothing carousel assembly 200 (after the elongated weight-transfer member 413 is inserted, at least in part, into the interior of the clothing carousel assembly 200). In this manner, the lock device 238 stops (locks) relative movement between the elongated weight-transfer member 413 and the clothing carousel assembly 200. It will be appreciated that the elongated weight-transfer members (411, 412, 413, 414) may each be configured to be locked with a respective lock device, if so desired.

Referring to the embodiment as depicted in FIG. 19, the free end of the elongated weight-transfer member 413 is positioned on the support member 502 after the lock device 238 securely connects the elongated weight-transfer member 413 to the clothing carousel assembly 200.

Referring to the embodiments of FIG. 18 and FIG. 19, the lock device 238 is configured to selectively lock the weight-transfer receivers (211, 212, 213, 214) to the elongated weight-transfer members (411, 412, 413, 414) after the weight-transfer receivers (211, 212, 213, 214) receive (at least in part, either directly and/or indirectly) and contact (at least in part, either directly and/or indirectly) the elongated weight-transfer members (411, 412, 413, 414).

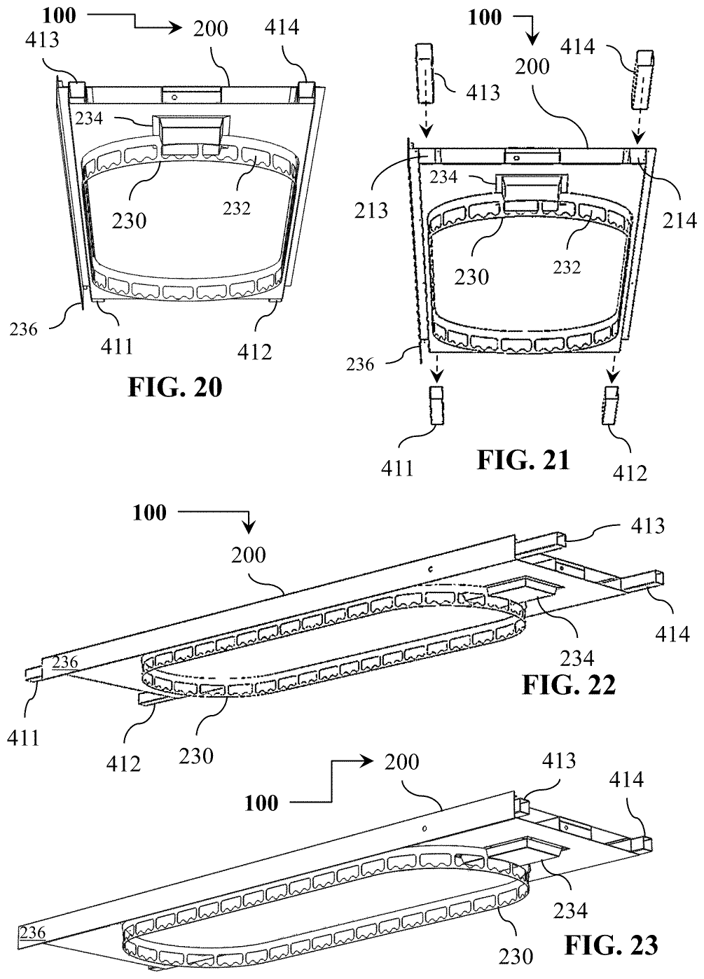

FIG. 20, FIG. 21, FIG. 22, and FIG. 23 depict lower perspective views of embodiments of the clothing carousel assembly 200 of FIG. 1.

Referring to the embodiments as depicted in FIG. 20 and FIG. 23, the elongated weight-transfer members (411, 412, 413, 414) are inserted (retracted into, at least in part) into the interior of the clothing carousel assembly 200.

Referring to the embodiment as depicted in FIG. 21, the elongated weight-transfer members (411, 412, 413, 414) are extracted, and fully removed, from the interior of the clothing carousel assembly 200.

Referring to the embodiments of FIG. 21, the elongated weight-transfer members (411, 412, 413, 414) are also configured to be retractable (movable), at least in part, within (toward) the clothing carousel assembly 200.

Referring to the embodiments of FIG. 21, the elongated weight-transfer members (411, 412, 413, 414) are also configured to be retractable, at least in part, into an interior of the clothing carousel assembly 200.

Referring to the embodiments of FIG. 21, the elongated weight-transfer members (411, 412, 413, 414) are also configured to be extendable, at least in part, away from the clothing carousel assembly 200. This arrangement is done in such a way that the elongated weight-transfer members (411, 412, 413, 414) are movable between a retracted position and an extended position.

Referring to the embodiments of FIG. 21, the elongated weight-transfer members (411, 412, 413, 414) are also configured to be extendable, at least in part, out from an interior (interior zone) of the clothing carousel assembly 200. This arrangement is done in such a way that the elongated weight-transfer members (411, 412, 413, 414) are movable between a retracted position and an extended position.

Referring to the embodiment as depicted in FIG. 22, the elongated weight-transfer members (411, 412, 413, 414) are partially extracted, but not fully removed, from the interior of the clothing carousel assembly 200.

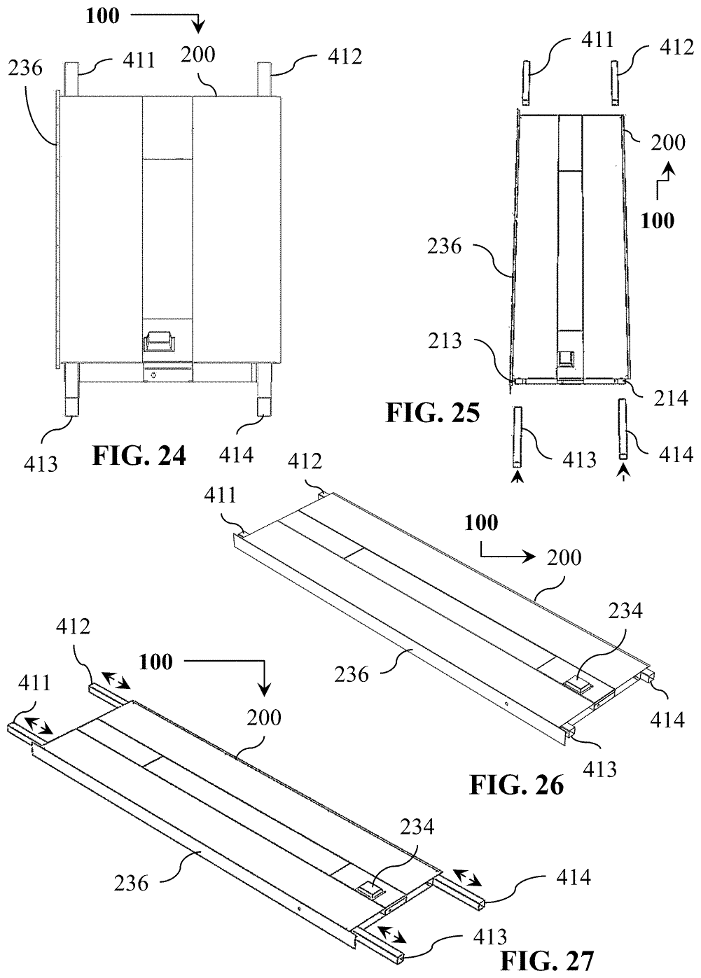

FIG. 24, FIG. 25, FIG. 26, and FIG. 27 depict upper perspective views of embodiments of the clothing carousel assembly 200 of FIG. 1.

Referring to the embodiments as depicted in FIG. 24 and FIG. 27, the elongated weight-transfer members (411, 412, 413, 414) are partially extracted, but not fully removed, from the interior of the clothing carousel assembly 200.

Referring to the embodiment as depicted in FIG. 25, the elongated weight-transfer members (411, 412, 413, 414) are extracted, and fully removed, from the interior of the clothing carousel assembly 200.

Referring to the embodiment as depicted in FIG. 26, the elongated weight-transfer members (411, 412, 413, 414) are inserted (retracted into, at least in part) into the interior of the clothing carousel assembly 200.

Referring to the embodiments of FIG. 26, in a retracted position, the elongated weight-transfer members (411, 412, 413, 414) are retracted (moved), at least in part, toward (into) the clothing carousel assembly 200.

Referring to the embodiment of FIG. 26, in a retracted position, the elongated weight-transfer members (411, 412, 413, 414) are retracted, at least in part, into an interior of the clothing carousel assembly 200.

Referring to the embodiments of FIG. 26 (and FIG. 2), in an extended position, the elongated weight-transfer members (411, 412, 413, 414) are extended, at least in part, away from an interior of the clothing carousel assembly 200.

Referring to the embodiments of FIG. 26 (and FIG. 2), in an extended position, the elongated weight-transfer members (411, 412, 413, 414) are extended, at least in part, away from an interior of the clothing carousel assembly 200. This arrangement is done in such a way that the elongated weight-transfer members (411, 412, 413, 414) contact, at least in part, the support members (501, 502), and the support members (501, 502) support the elongated weight-transfer members (411, 412, 413, 414) and the clothing carousel assembly 200 after the support members (501, 502) are mounted to the opposite walls (901, 902) of the closet 900 and after the clothing carousel assembly 200 is positioned between the opposite walls (901, 902) of the closet 900.

Referring to the embodiments of FIG. 27 (and FIG. 2), in an extended position, the elongated weight-transfer members (411, 412, 413, 414) are extended, at least in part, away from the clothing carousel assembly 200.

The following is offered as further description of the embodiments, in which any one or more of any technical feature (described in the detailed description, the summary and the claims) may be combinable with any other one or more of any technical feature (described in the detailed description, the summary and the claims). It is understood that each claim in the claims section is an open ended claim unless stated otherwise. Unless otherwise specified, relational terms used in these specifications should be construed to include certain tolerances that the person skilled in the art would recognize as providing equivalent functionality. By way of example, the term perpendicular is not necessarily limited to 90.0 degrees, and may include a variation thereof that the person skilled in the art would recognize as providing equivalent functionality for the purposes described for the relevant member or element. Terms such as “about” and “substantially”, in the context of configuration, relate generally to disposition, location, or configuration that are either exact or sufficiently close to the location, disposition, or configuration of the relevant element to preserve operability of the element within the disclosure which does not materially modify the disclosure. Similarly, unless specifically made clear from its context, numerical values should be construed to include certain tolerances that the person skilled in the art would recognize as having negligible importance as they do not materially change the operability of the disclosure. It will be appreciated that the description and/or drawings identify and describe embodiments of the apparatus (either explicitly or inherently). The apparatus may include any suitable combination and/or permutation of the technical features as identified in the detailed description, as may be required and/or desired to suit a particular technical purpose and/or technical function. It will be appreciated that, where possible and suitable, any one or more of the technical features of the apparatus may be combined with any other one or more of the technical features of the apparatus (in any combination and/or permutation). It will be appreciated that persons skilled in the art would know that the technical features of each embodiment may be deployed (where possible) in other embodiments even if not expressly stated as such above. It will be appreciated that persons skilled in the art would know that other options may be possible for the configuration of the components of the apparatus to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method steps. Comprising (comprised of) is an “open” phrase and allows coverage of technologies that employ additional, unrecited elements. When used in a claim, the word “comprising” is the transitory verb (transitional term) that separates the preamble of the claim from the technical features of the disclosure. The foregoing has outlined the non-limiting embodiments (examples). Furthermore, the term “a” is not intended to mean ‘one, and only one’, unless it would be understood by one skilled in the art that it would be necessary for it to mean ‘one, and only one’. In other instances, ‘a’ is intended to mean cat least one′. The description is made for particular non-limiting embodiments (examples). It is understood that the non-limiting embodiments are merely illustrative as examples.

What is claimed is:

1. An apparatus for a closet having opposite walls, and the apparatus also for clothing hangers being configured to receive and support clothing items, and the apparatus also for elongated weight-transfer members being configured to be securely connectable to the opposite walls of the closet, and the apparatus comprising:
a clothing carousel assembly being configured to receive, support, and selectively rotate the clothing hangers with the clothing items hanging from the clothing hangers along a rotation path; and
the clothing carousel assembly also being configured to be positioned between the opposite walls of the closet; and
the clothing carousel assembly including weight-transfer receivers being configured to receive and contact the elongated weight-transfer members.

2. The apparatus of claim 1, wherein:
the elongated weight-transfer members are also configured to be securely connectable to the opposite walls of the closet; and
the elongated weight-transfer members are also configured to receive, support and transfer the weight of the clothing carousel assembly to the opposite walls of the closet after:
the weight-transfer receivers, of the clothing carousel assembly, receive and contact the elongated weight-transfer members; and
the clothing carousel assembly is positioned between the opposite walls of the closet; and
the elongated weight-transfer members are securely connected to the opposite walls of the closet.

3. The apparatus of claim 1, wherein:
the clothing carousel assembly includes respective corner zones; and
the weight-transfer receivers include elongated structures being positioned at the respective corner zones of the clothing carousel assembly; and
the elongated weight-transfer members are configured to be slide receivable, at least in part, within the elongated structures of the weight-transfer receivers being respectively located at the respective corner zones of the clothing carousel assembly.

4. The apparatus of claim 1, further comprising:
a lock device being configured to selectively lock the weight-transfer receivers to the elongated weight-transfer members after the weight-transfer receivers receive and contact the elongated weight-transfer members.

5. The apparatus of claim 1, wherein:
the elongated weight-transfer members are also configured to be connectable to the opposite walls of the closet in such a way that the elongated weight-transfer members transfer the weight of the clothing carousel assembly supporting the clothing hangers with the clothing items toward the opposite walls of the closet after the elongated weight-transfer members are connected to the opposite walls of the closet.

6. The apparatus of claim 1, wherein:
the elongated weight-transfer members are also configured to be slide engageable with the clothing carousel assembly.

7. The apparatus of claim 1, wherein:
the elongated weight-transfer members are also configured to be retractable, at least in part, toward the clothing carousel assembly.

8. The apparatus of claim 1, wherein:
the elongated weight-transfer members are also configured to be extendable, at least in part, away from the clothing carousel assembly in such a way that the elongated weight-transfer members are movable between a retracted position and an extended position.

9. The apparatus of claim 1, wherein:
the elongated weight-transfer members are also configured to be extendable, at least in part, out from an interior of the clothing carousel assembly in such a way that the elongated weight-transfer members are movable between a retracted position and an extended position.

10. The apparatus of claim 1, further comprising:
support members configured to be securely attached to the opposite walls of the closet, wherein the support members are also configured to support the elongated weight-transfer members and the clothing carousel assembly with clothing carousel assembly.

11. The apparatus of claim 10, wherein:
the support members are also configured to support the elongated weight-transfer members and the clothing carousel assembly after the support members are securely attached to the opposite walls of the closet, and after the elongated weight-transfer members are moved away from the clothing carousel assembly and made to contact, at least in part, the support members.

12. The apparatus of claim 11, wherein:
in a retracted position, the elongated weight-transfer members are retracted, at least in part, toward the clothing carousel assembly.

13. The apparatus of claim 11, wherein:
in a retracted position, the elongated weight-transfer members are retracted, at least in part, into an interior of the clothing carousel assembly.

14. The apparatus of claim 11, wherein:
in a retracted position, the elongated weight-transfer members are retracted, at least in part, into an interior of the clothing carousel assembly in such a way that the elongated weight-transfer members are spaced-apart from the support members mounted to the opposite walls of the closet after the clothing carousel assembly is positioned between the opposite walls of the closet.

15. The apparatus of claim 11, wherein:
in an extended position, the elongated weight-transfer members are extended, at least in part, away from the clothing carousel assembly.

16. The apparatus of claim 11, wherein:
in an extended position, the elongated weight-transfer members are extended, at least in part, away from an interior of the clothing carousel assembly in such a way that the elongated weight-transfer members contact, at least in part, the support members, and the support members, in use, support the elongated weight-transfer members and the clothing carousel assembly after the support members are mounted to the opposite walls of the closet and after the clothing carousel assembly is positioned between the opposite walls of the closet.

17. A method for installing a clothing carousel assembly, having weight-transfer receivers, in a closet having opposite walls, and the clothing carousel assembly being configured to receive, support, and selectively rotate clothing hangers with clothing items hanging from the clothing hangers along a rotation path, and the method comprising:
receiving and contacting elongated weight-transfer members to the weight-transfer receivers of the clothing carousel assembly; and
positioning the clothing carousel assembly between the opposite walls of the closet; and
securely connecting the elongated weight-transfer members with the opposite walls of the closet so that the elongated weight-transfer members receive, support and transfer the weight of the clothing carousel assembly to the opposite walls of the closet after:
the weight-transfer receivers receive and made to contact the elongated weight-transfer members; and
the clothing carousel assembly is positioned between the opposite walls of the closet; and
the elongated weight-transfer members are securely connected to the opposite walls of the closet.

18. The method of claim 17, further comprising:
connecting elongated weight-transfer members to the opposite walls of the closet in such a way that the elongated weight-transfer members transfer the weight of the clothing carousel assembly supporting the clothing hangers with the clothing items toward the opposite walls of the closet after the elongated weight-transfer members are connected to the opposite walls of the closet.

19. The method of claim 17, further comprising:
extending, at least in part, the elongated weight-transfer members away from the clothing carousel assembly in such a way that the elongated weight-transfer members are movable between a retracted position and an extended position.

20. The method of claim 17, further comprising:
securely attaching support members to the opposite walls of the closet, in which the support members are configured to support the elongated weight-transfer members and the clothing carousel assembly after the support members are securely attached to the opposite walls of the closet, and after the elongated weight-transfer members are moved away from the clothing carousel assembly and made to contact, at least in part, the support members; and
wherein, in an extended position, the elongated weight-transfer members are extended, at least in part, away from an interior of the clothing carousel assembly in such a way that the elongated weight-transfer members contact, at least in part, the support members, and the support members, in use, support the elongated weight-transfer members and the clothing carousel assembly after the support members are mounted to the opposite walls of the closet and after the clothing carousel assembly is positioned between the opposite walls of the closet.
